(19) United States
(12) Patent Application Publication
(10) Pub. No.: US 2025/0202186 A1
(43) Pub. Date: Jun. 19, 2025

(54) ALL-OPTICAL LOCKING AND SYNCHRONIZATION OF A MICRORESONATOR FREQUENCY COMB TO A MASTER LASER FOR FREQUENCY COMB CONTROL AND STABILITY TRANSFER AND METHODS THEREOF

(71) Applicants: University of Maryland, College Park, College Park, MD (US); Government of the United States of America, as represented by the Secretary of Commerce, Gaithersburg, MD (US); University of Maryland, Baltimore County, Baltimore, MD (US)

(72) Inventors: Gregory Moille, College Park, MD (US); Kartik Srinivasan, Gaithersburg, MD (US); Curtis Menyuk, Baltimore, MD (US)

(21) Appl. No.: 18/915,463

(22) Filed: Oct. 15, 2024

Related U.S. Application Data
(60) Provisional application No. 63/610,281, filed on Dec. 14, 2023.

(51) Int. Cl. H01S 3/13; G02F 1/35; G02F 1/365; H01S 3/107

(52) U.S. Cl. CPC H01S 3/1305; G02F 1/3513; G02F 1/365; H01S 3/107

(57) ABSTRACT

A system for stabilization of optical frequency combs (OFCs) includes a first laser source configured to provide a first frequency laser; an optical reference source configured to provide a reference laser, wherein the reference laser is a second frequency laser different from the first frequency laser; and an optical microresonator. The optical microresonator includes a microring configured to generate OFCs; and a first waveguide configured to couple the first frequency laser to the microring. The optical microresonator is configured to generate a passive Kerr-induced synchronization (KIS) of the OFCs to the reference laser.

### CROSS-REFERENCE TO RELATED APPLICATION AND CLAIM OF PRIORITY

This application claims the benefit of, and priority to, U.S. Provisional Patent Application No. 63/610,281, filed on Dec. 14, 2023, the entire contents of which are hereby incorporated herein by reference.

### GOVERNMENT SUPPORT

This invention was made with government support under 70NANB21H126 awarded by the National Institute of Standards and Technology, FA9550-20-1-0357 awarded by the Air Force Office of Scientific Research, and ECCS1807272 awarded by the National Science Foundation. The government has certain rights in the invention.

### TECHNICAL FIELD

The present disclosure relates generally to optical frequency combs (OFCs). More specifically, the present disclosure relates to the stabilization of OFCs to an external optical reference.

### BACKGROUND

Optical frequency combs (OFCs) are unique metrological tools that provide a phase-coherent link between the optical and microwave domains through their repetition rate. Further, OFCs serve as an essential component of optical frequency synthesis, which involves transferring microwave stability to the optical domain, and optical clocks, which involve the transfer of ultra-high optical stability to the microwave domain. These optical clocks rely on stable lasers locked to an environmentally-insensitive optical transition. The usage of on-chip optical clockworks, primarily via OFCs based on dissipative Kerr solitons (DKS) in microring resonators, does not eliminate the need for the active locking of a single OFC comb tooth to a reference laser. The power budget and limited bandwidth associated with such active stabilization represents a barrier to achieving full integration of an optical clock, even if the power required to optically drive the integrated OFC is low.

Accordingly, there is a need for the stabilization of OFCs to an external optical reference.

### SUMMARY

An aspect of the present disclosure provides a system for stabilization of optical frequency combs (OFCs). The system includes a first laser source configured to provide a first frequency laser; an optical reference source configured to provide a reference laser, wherein the reference laser is a second frequency laser different from the first frequency laser; and an optical microresonator. The optical microresonator includes a microring configured to generate OFCs; and a first waveguide configured to couple the first frequency laser to the microring. The optical microresonator is configured to generate a passive Kerr-induced synchronization (KIS) of the OFCs to the reference laser.

In accordance with aspects of the disclosure, the OFCs may include a plurality of comb teeth. The reference laser may be injected in the optical microresonator and configured to cause the OFC, created by the first laser, to adapt its repetition rate and CEO such that a comb tooth, of the plurality of comb teeth, becomes indistinguishable in frequency and phase with the reference laser.

In accordance with aspects of the disclosure, the dual pinning from the first laser generating the OFC and the reference laser triggering the Kerr-induced synchronization of the system may enable the bypassing of an in intrinsic noises limitation of the system, following a physics of nonlinear dissipative system attractors, and may improve a performance of the system up to a performance of the first laser and reference laser.

In accordance with aspects of the disclosure, the system may be configured to generate an ultra-low noise microwave signal based on the first laser and a reference laser being stabilized to the optical reference.

In accordance with aspects of the disclosure, the capture by the reference laser of the comb tooth through Kerr-induced synchronization may cause an increase in comb tooth power at and around the frequency of the reference laser.

In accordance with aspects of the disclosure, the reference laser may cause a capture of the comb tooth through Kerr-induced synchronization enables self-balancing of the OFCs, increasing a power of the comb teeth on the other side of an OFC spectrum than the reference laser respective to the first laser.

In accordance with aspects of the disclosure, the system may enable for higher signal to noise ratio in a detection of carrier envelope offset (CEO) from a nonlinear interferometry between the doubled the reference laser and a closet comb tooth.

In accordance with aspects of the disclosure, the complete locking of the OFC through dual-pinning from the reference laser and locked CEO may be provided by servo feedback onto the first laser to lock CEO, with or without the reference laser stabilized to an optical reference.

In accordance with aspects of the disclosure, the system may be configured for optical clockwork operation, timekeeping, and/or self-reference OFC operation.

In accordance with aspects of the disclosure, the reference laser may be optically modulated to create sidebands, frequency separated from the reference laser by the modulation frequency, which may capture the closest comb tooth, and may provide Kerr-induced synchronization from one of the sidebands of the reference laser.

In accordance with aspects of the disclosure, the OFCs may include a plurality of teeth. The system may be configured to pin a first tooth of the plurality of teeth through carrier-envelope offset (CEO) frequency (ω_{ceo}) stabilization and the first laser source may be a dissipative Kerr solution (DKS) pump laser.

In accordance with aspects of the disclosure, the servo may be configured to tune the first laser source based on the CEO frequency.

In accordance with aspects of the disclosure, the system may be configured to reduce an intrinsic noise of a repetition rate of the plurality of teeth based on the passive KIS.

In accordance with aspects of the disclosure, the system may be configured to stabilize ω_{ceo} based on feeding back ω_{ceo} to the first laser source.

In accordance with aspects of the disclosure, the system may further include a second harmonic generator configured to double a frequency of the reference laser. The doubled frequency of the reference laser is beat against a closest in frequency comb tooth of the plurality of teeth.

In accordance with aspects of the disclosure, the system may further include a second waveguide configured to couple the reference laser to the microring.

In accordance with aspects of the disclosure, the reference laser may be coupled to the microring by the first waveguide.

In accordance with aspects of the disclosure, a noise reduction may be determined by an energy exchange rate of the system.

An aspect of the present disclosure provides a method for stabilization of optical frequency combs (OFCs). The method includes providing by a first laser source a first frequency laser; providing by an optical reference source a reference laser, wherein the reference laser is a second frequency laser different from the first frequency laser; and generating a passive Kerr-induced synchronization (KIS) of the OFCs to the reference laser by an optical microresonator. The optical microresonator includes a microring configured to generate OFCs, wherein the OFCs include a plurality of teeth; and a first waveguide configured to couple the first frequency laser to the microring.

In accordance with aspects of the disclosure, the method may further include pinning a first tooth of a plurality of teeth through carrier-envelope offset (CEO) frequency (ω_{ceo}) stabilization.

In accordance with aspects of the disclosure, the method may further include tuning, by a servo, the first laser source based on the CEO frequency.

In accordance with aspects of the disclosure, the method may further include generating a beat note between the first laser frequency and the second laser frequency; measuring the beat note; and generating a control signal for tuning the first laser source based on the measured beat note.

In accordance with aspects of the disclosure, the method may further include reducing an intrinsic noise of a repetition rate of the plurality of teeth based on the passive KIS.

In accordance with aspects of the disclosure, the method may further include stabilizing an angular frequency of a carrier envelope offset (ω_{ceo}) based on feeding back ω_{ceo} to the first laser source.

In accordance with aspects of the disclosure, the method may further include doubling a frequency of the reference laser; and beating the doubled frequency of the reference laser against a closest in frequency comb tooth of the plurality of teeth.

In accordance with aspects of the disclosure, the method may further include coupling by a second waveguide the reference laser to the microring.

In accordance with aspects of the disclosure, the method may further include coupling the reference laser to the microring by the first waveguide.

An aspect of the present disclosure provides a system for stabilization of optical frequency combs (OFCs). The system includes an optical microresonator including: a microring configured to generate OFCs; and a first waveguide configured to couple a first frequency laser and a second frequency laser to the microring. The optical microresonator is configured to generate a passive Kerr-induced synchronization (KIS) of the OFCs to the second frequency laser, the second frequency laser being lower in frequency than the first frequency laser. The system is configured for enabling a noise reduction, which is determined by an energy exchange rate of the system.

Further details and aspects of exemplary embodiments of the present disclosure are described in more detail below with reference to the appended figures.

### BRIEF DESCRIPTION OF THE DRAWINGS

A better understanding of the features and advantages of the present disclosure will be obtained by reference to the following detailed description that sets forth illustrative embodiments, in which the principles of the present disclosure are utilized, and the accompanying drawings of which:

FIG. 1 is a diagram of an exemplary device for stabilization of optical frequency combs (OFCs), in accordance with examples of the present disclosure;

FIG. 2 is a block diagram of a microresonator of the system of FIG. 1, in accordance with aspects of the present disclosure;

FIG. 3 is a diagram of the microresonator of FIG. 2 illustrating the circumvention of DKS thermos-refractive noise through Kerr-induced synchronization (KIS), in accordance with aspects of the present disclosure;

FIG. 4 is a diagram illustrating noise propagation of a single-pumped microcomb following an elastic-tape model, in accordance with aspects of the present disclosure;

FIG. 5 is a diagram illustrating using KIS, dual-pinning of the comb through the introduction of the reference now prevents any RIN transduction onto the comb teeth frequency noise, in accordance with aspects of the present disclosure;

FIG. 6 is a diagram illustrating an optical spectrum of an experimental microcomb obtained with a main pump, in accordance with aspects of the present disclosure;

FIG. 7 is a diagram illustrating effective linewidths of individual comb teeth, in accordance with aspects of the present disclosure;

FIG. 8 is a diagram illustrating an eigenvalue spectrum of the linearized operator (dynamical spectrum) in the unsynchronized case, in accordance with aspects of the present disclosure;

FIG. 9 is a diagram illustrating an eigenvalue spectrum of an edge of the KIS window corresponding to λₚₛ=−10⁻², in accordance with aspects of the present disclosure;

FIG. 10 is a diagram illustrating an eigenvalue spectrum offset from the center of the KIS window at λₚₛ=−10⁻¹, in accordance with aspects of the present disclosure;

FIG. 11 is a diagram illustrating an eigenvalue spectrum at the center of the KIS window at λₚₛ=−1, in accordance with aspects of the present disclosure;

FIG. 12 is a graph illustrating a power spectral density of the repetition rate noise, in accordance with aspects of the present disclosure;

FIG. 13 is a graph illustrating power vs frequency spectrum of an octave-spanning microcomb, in accordance with aspects of the present disclosure;

FIG. 14 is a graph illustrating frequency noise for a single pumped microcomb with a frequency-locked cooler, in accordance with aspects of the present disclosure;

FIG. 15 is a diagram illustrating an unsynchronized signal, in accordance with aspects of the present disclosure;

FIG. 16 is a diagram illustrating KIS at a physics level, in accordance with aspects of the present disclosure; and

FIG. 17 is a diagram illustrating an experimental demonstration of KIS, in accordance with aspects of the present disclosure.

### DETAILED DESCRIPTION

The present disclosure relates generally to optical frequency combs (OFCs). More specifically, the present disclosure relates to the stabilization of OFCs to an external optical reference.

Although the present disclosure will be described in terms of specific examples, it will be readily apparent to those skilled in this art that various modifications, rearrangements, and substitutions may be made without departing from the spirit of the present disclosure.

For the purpose of promoting an understanding of the principles of the present disclosure, reference will now be made to exemplary embodiments illustrated in the drawings, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

Optical frequency combs provide a coherent optical-to-microwave frequency link, enabling accurate optical frequency measurement, which has applications in optical frequency synthesis, spectroscopy, microwave signal generation, and ranging, among others applications. To further lower the size, weight, and power consumption (SWaP) of combs for deployable applications, on-chip microcombs may be created by taking advantage of nonlinear photonic devices. Leveraging the third-order nonlinearity (χ⁽³⁾), integrated microring resonators can be designed to support dissipative Kerr soliton (DKS) states that exist by doubly balancing the loss/gain and dispersion/nonlinear phase shift of the system, which once periodically extracted create a uniformly spaced pulsed train, and hence an on-chip frequency comb.

While many applications of table-top frequency combs have been reproduced at the chip-scale thanks to DKSs, these integrated microcombs fall short in their repetition rate noise performance, primarily due to their poor ability to manage the cavity thermorefractive noise (TRN), which increases inversely with the resonator size. Since TRN locally modifies the material refractive index, the cavity soliton experiences transduction of this noise onto both its group and phase velocity, which respectively impact the repetition rate and the carrier envelope offset (CEO) of the microcomb. This noise transduction is particularly consequential for octave-spanning micro combs, where CEO detection and stabilization is a focus, and where SWaP considerations favor a high repetition rate to maximize individual comb tooth power within an octave, resulting in the use of a small microring resonator. Mitigation of TRN is possible, for instance through judicious use of a cooler-laser that can squeeze the resonator temperature fluctuations under low cooler power, leading to an improvement in the repetition rate noise by about an order of magnitude.

Other promising methods such as dispersion engineering to tailor the recoil and counterbalance TRN have been proposed, and could potentially fully quench it. Yet, such engineering is challenging for octave-spanning combs since the dispersion would need to simultaneously support the desired microcomb bandwidth and the required asymmetry for TRN suppression. A final solution is to strongly suppress TRN by working at cryogenic temperature, which reduces the thermorefractive coefficient by more than two orders of magnitude and enables direct and adiabatic DKS generation. Though very effective at removing TRN and other vibrational-based noise sources (e.g., Raman scattering), the significant infrastructure requirements are incompatible fieldable applications. Beyond repetition rate noise, the individual comb tooth linewidths, which are directly related to the noise of the main pump laser generating the DKS through a so-called elastic-taped model, can also be a limitation. Here, the frequency noise power spectral density (PSD) of the pump laser propagates quadratically with the comb tooth mode number, which in the temporal domain corresponds to a quadratic increase of noise between pulses separated by harmonics of the repetition period, and broadens the comb teeth beyond the linewidth of the pump laser. For octave-spanning combs, where comb teeth that are hundreds of modes away from the pump are used (e.g., in self-referencing), this can be a significant limitation.

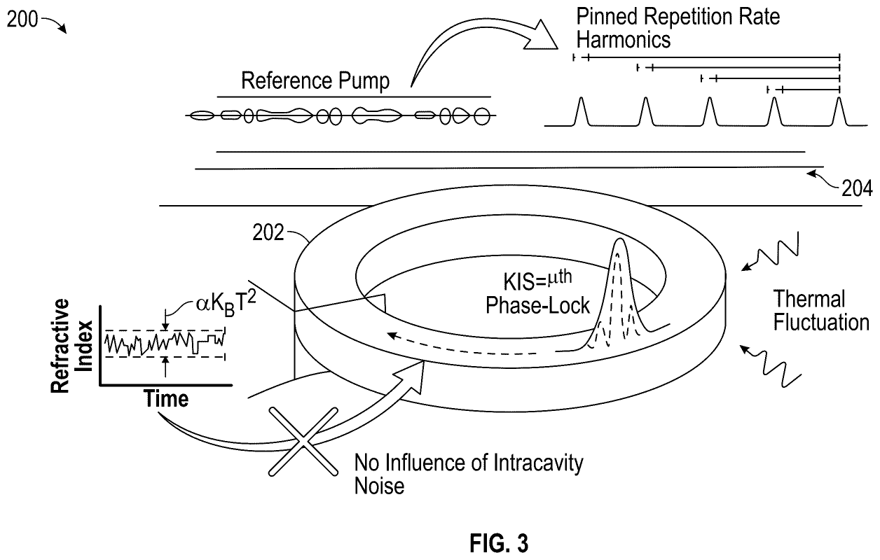

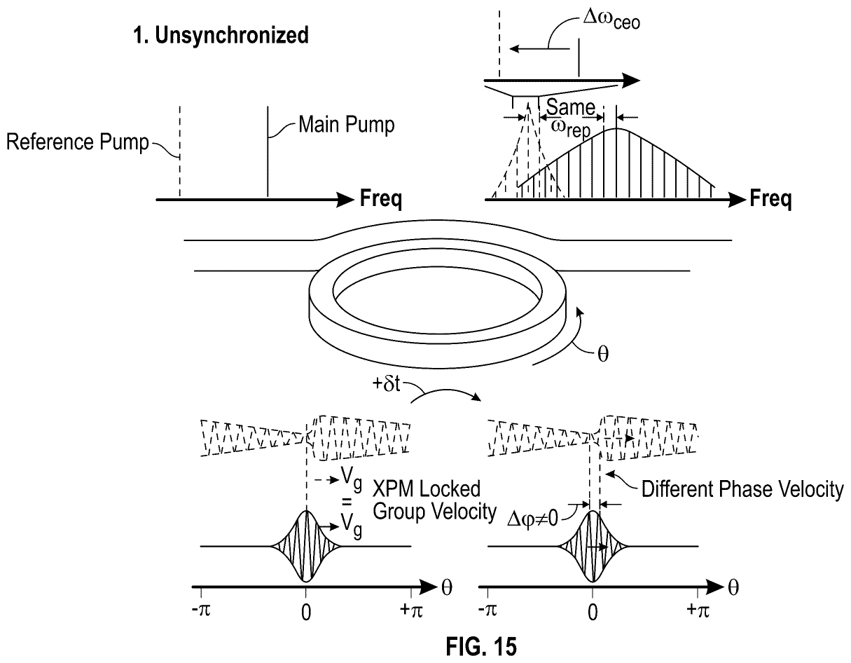

The disclosed technology provides the technical solution to the above-noted problems by leveraging Kerr-induced synchronization (KIS). KIS is a method to stabilize the DKS. KIS relies on the phase locking of the intra-cavity soliton to an external reference laser injected in the same resonator where the soliton circulates, which locks their respective CEOs (FIG. 3). The resulting system corresponds to the OFC where the comb tooth whose frequency that is the closest to the reference laser becomes indistinguishable from the reference laser (i.e. the OFC adapts to match this given comb tooth frequency and phase to match that of the reference laser (FIGS. 15-17). This method is highly versatile as any comb line can be synchronized, and multi-color synchronization that stabilize, the common repetition rate can also be achieved. It allows for a passive and all-optical stabilization of the microcomb to an optical frequency reference, providing long-term stability for clockwork applications with optical frequency division of the pumps' noise onto the repetition rate. Mathematically, the injection of another laser into the DKS's resonator allows for the existence of a new attractor, which is reached when entering the KIS regime. Since attractors in nonlinear systems only occur when they are dissipative, not only does the amplitude of the energy exchange matter, but so does the characteristic time scale of the energy exchange, which, in this case, is the photon lifetime.

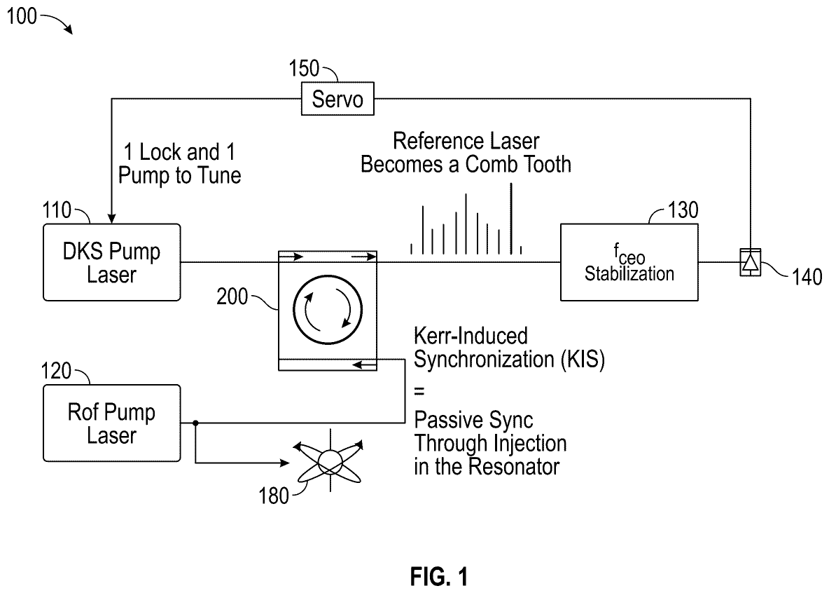

Referring to FIG. 1, a diagram of an example system 100 for stabilization of optical frequency combs (OFCs) is shown. The system 100 generally includes a first laser source 110 (e.g., a DKS laser pump or a main pump) configured to provide a first frequency laser, a reference source (e.g., a reference pump laser) 102 configured to provide a reference laser, and an optical microresonator 200. The system may further include a servo 150 (e.g., a feedback control mechanism) configured to keep the first laser source's frequency stable by comparing the actual frequency to a desired reference and adjusting the laser's parameters (e.g., current or temperature). For example, the servo 150 may include a PID controller which adjusts the laser parameters based on the error between the actual frequency and the desired reference. The controller uses proportional, integral, and derivative terms to minimize the error over time. In another example, the servo 150 may include a phase-locked loop configured to continuously compare the phase of the laser output with that of the reference and adjust the laser parameters to minimize the phase difference. In another aspect, the servo 150 may include a nonlinear optical mixer (such as a photodetector) to combine the output of the frequency comb and the reference laser. The mixing process generates a beat signal at a frequency equal to the difference between the frequencies of the comb line and the reference laser. In aspects, the reference laser and/or the first laser may be free running or stabilized to an optical reference. The optical reference may include, for example, an optical cavity, or an atomic clock such as a cesium standard or a rubidium standard.

Although a microresonator 200 is used as an example, other microresonator geometries are contemplated, including microdisks, photonic crystal microrings, Fabry-Perot cavities with photonic crystal or Bragg grating mirrors, and/or one-dimensional and/or two-dimensional photonic crystal geometries

System 100 may further include a photodetector 140 configured to convert light into electricity. The beat signal is detected using the photodetector 140, such as an avalanche photodiode (APD), which converts the optical signal into an electrical signal. This beat signal will typically contain multiple frequency components corresponding to the various comb lines. System 100 may further include a photo diode 140 configured to convert light into electricity. In aspects, the system 100 may include a f_{ceo} stabilization circuit configured to stabilize the carrier envelope offset. In aspects, the system 100 may include a filter 130 configured to isolate the comb tooth of interest. In aspects, the system 100 may include a cooler pump (not shown) configured to thermally stabilize a temperature of the optical microresonator 200.

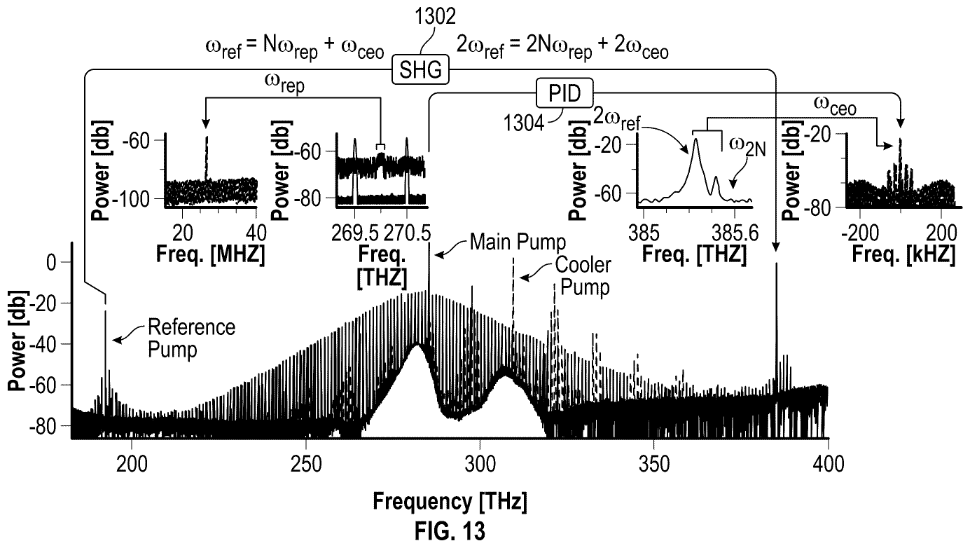

In aspects, the system 100 may further include a second-harmonic generation (SHG) nonlinear crystal 1302 configured to generate a doubled frequency of the reference laser frequency to beat against the closet comb tooth at 2f (FIG. 13).

In aspects, the system 100 may enable the phase locking of the OFCs to the reference laser.

In aspects, the OFCs include a plurality of comb teeth. A reference laser may be injected in the optical microresonator and may cause the first laser to lock a comb tooth closest in frequency to the frequency of the reference laser.

In aspects, the system 100 may utilize dual pinning from the first laser and the reference laser to trigger the KIS of the system and enable bypassing of an intrinsic noise limitation of the system, following a physics of nonlinear dissipative system attractors, and improving a performance of the system up to a performance of the first laser and the reference laser. For example, the improvement in performance may include a reduction in the repetition rate phase noise of the system relative to a single pumped microcomb. In another example, the improvement in performance may include a long term stability of the OFC repetition rate noise relative to that of a single pumped microcomb.

In aspects, the system 100 may be configured to generate an ultra-low noise microwave signal based on the first laser and a reference laser being stabilized to the optical reference. For example, the ultra-low noise microwave signal may be, a 14 GHz signal with a phase noise of −60 dBc/Hz at 1 Hz offset, and −135 dBc/Hz at 10 KHz offset from carrier.

In aspects, a capture of the comb tooth by the reference laser through Kerr-induced synchronization causes an increase in comb tooth power at and around the frequency of the reference laser. For example, the increase in power is relative to a single pumped microcomb.

In aspects, the reference laser may cause a capture of the comb tooth KIS that enables self-balancing of the OFCs, increasing a power of the comb teeth on an opposite side of an OFC spectrum than the reference laser respective to the first laser.

In aspects, the system may enable a higher signal to noise ratio in a detection of carrier envelope offset (CEO) from a nonlinear interferometry between the doubled the reference laser and a closest comb tooth to the doubled reference laser.

In aspects, the system 100 may completely lock the OFC through dual-pinning from the reference laser and locked CEO is provided by servo feedback onto the first laser to lock CEO, with or without the reference laser stabilized to an optical reference. In aspects, complete locking of the OFC through dual-pinning from the first laser and locked CEO may be provided by servo feedback onto the reference laser to lock the CEO, with or without the first laser stabilized to an optical reference. In aspects, the system 100 may be configured for optical clockwork operation, timekeeping, and/or self-referenced OFC operation.

In aspects, the reference laser may be optically modulated to create sidebands, frequency separated from the reference laser by the modulation frequency, which captures the closest comb tooth, providing Kerr-induced synchronization from one of the sidebands of the reference laser.

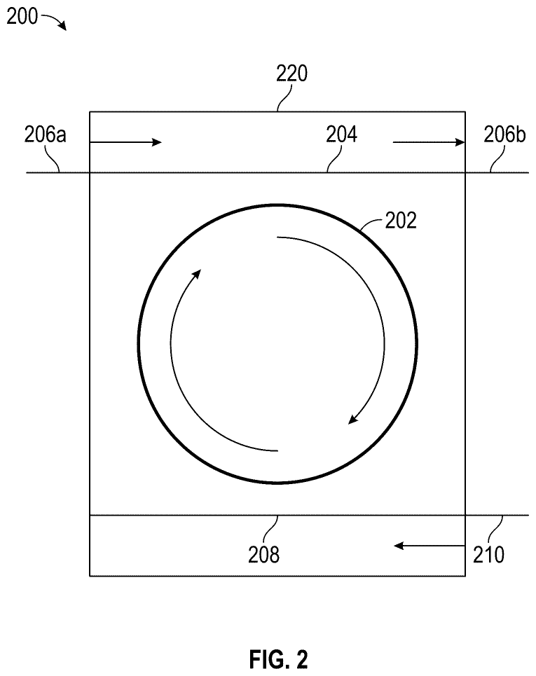

Referring to FIGS. 2 and 3, the optical microresonator 200 of system 100 of FIG. 1 is shown. The optical microresonator 200 is configured to generate a passive Kerr-induced synchronization (KIS) of the OFCs to the reference laser 120. The optical microresonator 200 includes a microring 202 configured to generate OFCs, and a first waveguide 204 configured to couple the first frequency laser to the microring 202. In aspects, the optical microresonator 200 may include a second waveguide 208, configured to couple the reference laser to the microring 202. The microring 202 and the waveguides 204, 208 may be on a common substrate 220. The first waveguide 204 includes a first port 206a and a second port 206b, both configured for optical communication with the first laser source 110. The second waveguide includes a first port 210 and a second port (not shown), both configured for optical communication with the reference laser 120.

In Kerr-induced synchronization, the reference laser is sent to the microcavity where the DKS lives, resulting in a phase locking of the cavity soliton to the reference phase velocity. Since the soliton repetition rate is now determined by external parameters that are the two pump frequencies, intrinsic noise sources such as TRN are bypassed and no longer affect the DKS repetition rate. In addition, a microcomb is now dual-pinned at the comb tooth closest to the reference laser 120 frequency and at the main pump (e.g., the first laser source 110) frequency, resulting in noise propagation onto the comb teeth that are damped relative to a single pump case.

KIS enables profound improvements in the repetition rate noise and individual comb tooth noise in DKS microcombs. The addition of a second interactivity field through the reference modifies the elastic-tape model describing the increase of the comb tooth linewidth away from the main pump such that under KIS, all comb tooth linewidths remain within the same order of magnitude across a span of more than 200 comb lines. Synchronization through the reference laser changes the soliton's dynamics such that any internal cavity noise, and in particular TRN, is damped at a rate proportional to the photon lifetime. This behavior, which is expected for dissipative system attractors, essentially bypasses current limitations on microcomb noise performance (FIG. 3) and enables any cavity size to perform at the same noise level as a large resonator.

Using an octave-spanning integrated microcomb with a volume of about 80 μm³, for which lower repetition rate noise was obtained than the TRN-limited value while using free-running pumps.

System 100 enables individual comb tooth linewidth reduction in KIS. First, the optical linewidth of the individual teeth forming the comb is useful in applications such as optical frequency synthesis and spectroscopy, where having narrow individual comb teeth is essential. Free running operation will be described, where two main noise sources from the DKS pump laser can be considered: frequency noise and residual intensity noise (RIN); laser shot noise will be neglected since the frequency noise will be orders of magnitude larger when not locked to a stable reference cavity.

In the single-pumped DKS, noise propagation from the pump, either from its frequency noise or RIN, to the microcomb teeth follows the well-known elastic-tape model. Interestingly, the frequency noise must account for soliton-recoil, which can appear from the Raman self-frequency shift and/or dispersive wave-induced rebalancing where the center of mass of the DKS must be null. Here, the Raman effect is neglected since its impact is marginal in Si₃N₄ compared to other materials, and it is assumed that the recoil mostly comes from the imbalance of the DW powers, creating a shift of the center of mass. The PSD of a comb tooth, referenced to the main pump (μ=0), can be written as S^{1p}(μ, f)=S_{ωrin}^{1p}(μ, f)+S_{ω}^{1p}(μ, f), with S_{ωrin}^{1p}(μ, f)=S_{ωrin,p}(f)μ², where S_{ωrin,p} already accounts for the power-to-frequency noise transduction from the pump and the frequency noise PSD defined as:

$${S}_{ω}^{1 p} ( μ , f ) = {S}_{ω , p} ( f ) {( 1 - \frac{\partial {ω}_{rep}}{\partial {ω}_{p}} μ )}^{2} \qquad ( 1 )$$

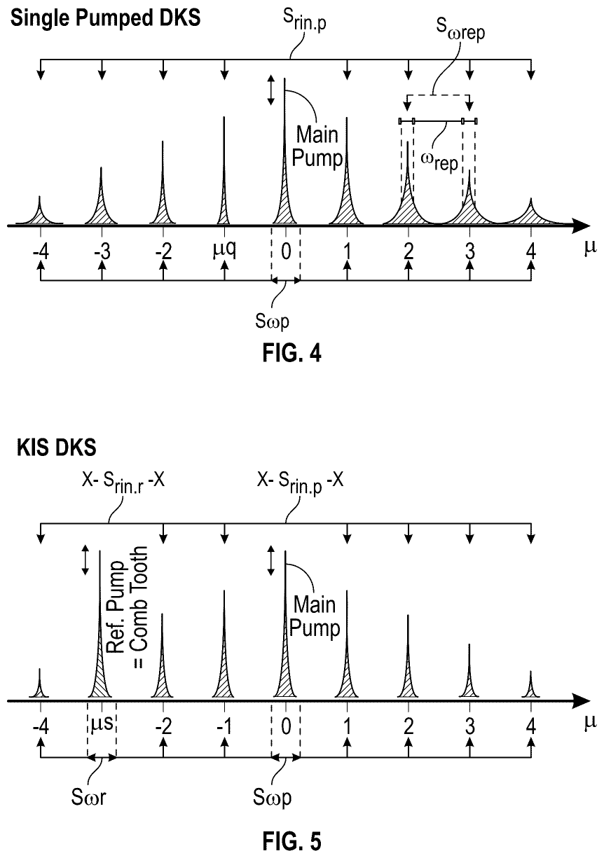

Here, S_{ω,p} is the frequency noise PSD of the main pump, ωᵣₑₚ is the repetition rate, and ωₚ is the main pump frequency. Therefore, the main pump noise cascades onto the comb teeth at a quadratic rate (FIG. 4). The superscript 1p refers to the single-pump DKS operation, which will be compared against the KIS regime. It thus becomes obvious that, apart from a quiet comb tooth at

$${μ}_{q} = {( \partial {ω}_{r e p} / \partial {ω}_{p} )}^{- 1} ,$$

the noise propagation makes the individual comb teeth broader than the pump itself, in particular for teeth far from the pump. As this noise propagation is a hindrance on performance. Since KIS involves phase locking of the frequency components at the reference mode s, resulting in the capture of the comb tooth closest to the reference pump laser, the noise propagation from the pump lasers will be largely different from the single pump regime (FIG. 5). As used herein the terms lock, pin, and capture are used synonymously.

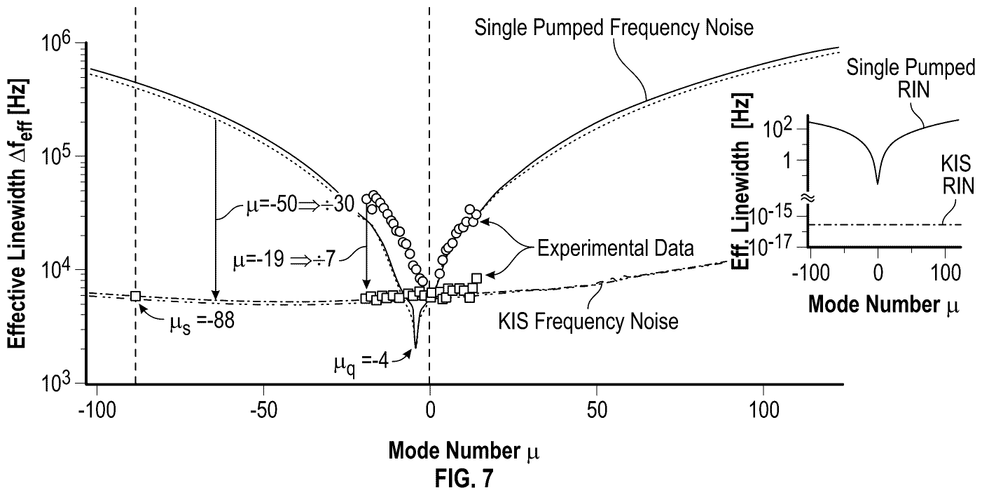

First, the microcomb is now fully defined by the frequency of both lasers, regardless of their power. Thus, as long as the cavity soliton remains within the KIS bandwidth, which is dependent on the DKS μₛ modal component and reference intracavity energies and is about 1 GHz here, the impact of RIN from both pumps on the individual comb teeth will be entirely suppressed, such that S_{ωrin}^{kis}(μ)=0 (FIG. 7) where the kis superscript refers to the KIS regime.

Hence, in the approximation to dismiss for the moment the microring intrinsic noise, the only contribution to the individual comb tooth noise PSD S^{kis}(μ) comes from the frequency noise cascading of both pumps. Since the captured comb tooth and the reference pump became indistinguishable in KIS, the comb tooth frequency noise is now pinned at each of the two pumps. In addition, the repetition rate noise must be the same for any two adjacent comb teeth considered. Hence, the noise propagation must also follow an elastic-tape model, this time adjusted for the dual-pinning such that:

$${S}_{ω}^{kis} ( μ , f ) = {S}_{ω , p} ( f ) {( 1 - \frac{μ}{{μ}_{s}} )}^{2} + {S}_{ω , r} ( f ) {( - \frac{μ}{{μ}_{s}} )}^{2} \qquad ( 2 )$$

with S_{ω,r} the frequency noise PSD of the reference pump and μₛ the comb tooth order undergoing KIS. Assuming the same frequency noise for both pump lasers S_{ω,p}=S_{ω,r}, and that S_{ωrin}(μ)<<S_{ω}(μ), which is obviously true in the KIS case and has been demonstrated in the single pump regime, one will observe S_{ω}^{1p}<S_{ω}^{kis} for the modes μ=[2μₛμ_{q}(μₛ−μ_{q})/μₛ²−2μ_{q}²; 0]. One of the main advantage of KIS is the possibility to dual pin the microcomb's widely-separated modes, while the recoil responsible for μ_{q} is usually close to the main pump. Hence, assuming μₛ>>μ_{q}, the single pump comb teeth PSD will only be better than the KIS one for a range μ=[2μ_{q}; 0], which by definition is narrow since μ_{q} is small. In contrast, the KIS microcomb will exhibit better single comb line frequency noise PSD performance across a broadband spectrum. Interestingly, in KIS when S_{ω,p}≈S_{ω,r}, a new quiet point at μ_{q}=φₛS_{ω,r}/(S_{ω,p}+S_{ω,r}) will be present with a PSD reduction of twice from the pump's PSD average. However, in the case of S_{ω,r}>>S_{ω,p} (S_{ω,r}<<S_{ω,p}) the lowest comb tooth noise will be at the main pump μ_{q}=0 (reference pump μ_{q}=μₛ).

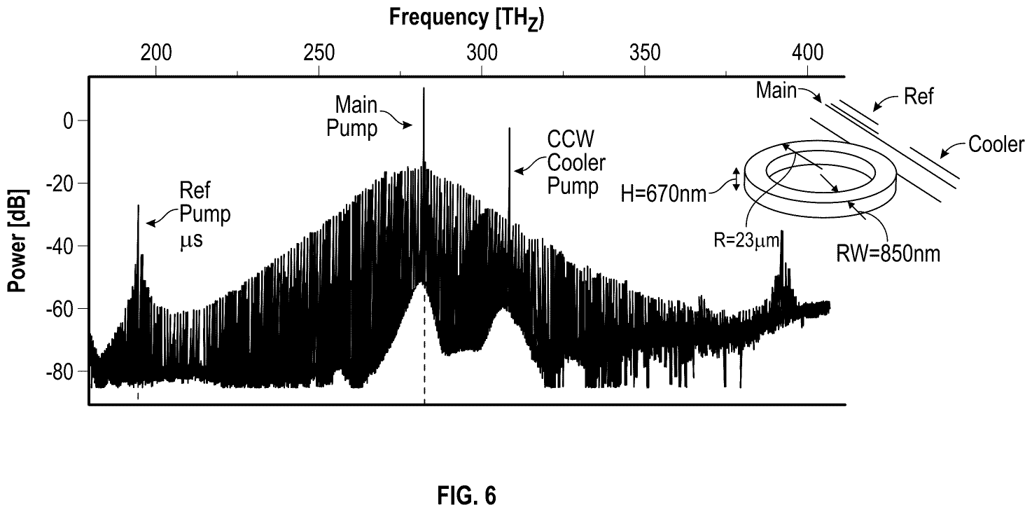

To demonstrate such performance improvement through KIS, an integrated microring resonator (FIG. 2) made of H=670 nm thick Si₃N₄ embedded in SiO₂, with a ring radius of R=23 μm and a ring width of RW=850 nm is used. This design provides anomalous dispersion around 283 THz (1060 nm) with higher-order dispersion providing nearly harmonic dispersive waves (DWs) at 194 THz and 388 THz, corresponding to μ=−88 and μ=110 respectively (FIG. 6). The individual comb lines were measured from μ=−19 to μ=14 using a high-rejection and narrowband optical filter and an optical frequency discriminator, while both main and reference pumps remain free running with an effective linewidth Δf_{eff}≈5.8 kHz determined from the laser PSD measurement following the definition ∫_{Δf}_{_{eff}}^{+∞}Sω(f)/∫²df=1/π. In the KIS regime, the measured comb teeth effective linewidths remain in the 5 kHz to 7 kHz range, obtained from their frequency noise spectra in a similar fashion as the pumps. The experimental data closely matches Lugiato-Lefever equation (LLE) simulations accounting for both pumps, which in addition matches the dual-pinned elastic-taped model introduced above. Here, the experimentally measured frequency noise PSD for each pump is input into the LLE simulation. Such close agreement between the model and the experimental data enables us to predict a comb tooth linewidth that will not exceed Δf_{eff}=15 kHz for modes as far as μ=+120. In sharp opposition, the predicted noise of the single pump case, which matches between the LLE and analytical model assuming a quiet comb line at μₚ=−4 obtained from the maximum of the sech² envelope of the experimental microcomb, yields an effective linewidth above 50 kHz (10× that of the main pump) for modes below μ=−28 or above μ=22, and as high as 500 kHz for modes close to the DWs. Experimentally, such a trend was confirmed, where Δf_{eff} increases with separation from the main pump, with Δf_{eff}≈40 kHz for μ=−19. However, a quiet mode was not observed in the measurements, and instead all comb lines exhibit higher noise than the pump.

This discrepancy, which has been observed previously, is mostly related to TRN that is not yet accounted for in the model. The lack of impact of its absence in modeling the KIS results already hints at its quenching in that regime, while it is the predominant noise source in the single pump case. Additionally, LLE simulations confirm the intuition that pump RIN has been entirely removed from influencing the effective linewidths of the comb teeth in the KIS regime (FIG. 7 inset), while it is a non-negligible contribution in the single pump case. Such modification of the elastic tape model for comb tooth noise could also provide valuable insights into other systems where similar injection locking of a comb tooth occurs. The recycling of a comb tooth for self-injection locking back into the comb results in a reduction in the comb teeth linewidths over a large modal span, akin to what is presented here.

Since there is good agreement between KIS experimental data and the theoretical dual-pinned elastic tape model that only accounts for pump frequency noise, while the single pump case presents a discrepancy which can likely be attributed to TRN, the microring resonator's intrinsic noise and how KIS modifies its impact on the cavity soliton is described. With this in mind, noise of the repetition rate ωᵣₑₚ of the comb rather than noise of individual comb lines, since regardless of operating in KIS or the single pump regime, noise propagates through an elastic-tape model.

A linear stability analysis of the LLE for the cavity soliton outside of synchronization (i.e., akin to single pump operation) and in the KIS regime is performed. The starting point is the multi-driven LLE (MLLE), normalized to losses which can be written as:

$$\frac{\partial ψ}{\partial t} = - ( 1 + t {α}_{p} ) ψ + i {\sum }_{α} 𝒟 ( μ ) \tilde{Ψ} {e}^{i μ θ} + i {\vert ψ \vert}^{2} ψ + {F}_{p} + {F}_{rel} exp [ i ( {α}_{rel} - {α}_{p} + 𝒟 ( {μ}_{s} ) ) t - i {μ}_{s} θ ] \qquad ( 3 )$$

where ψ is the normalized intracavity field of the DKS S2, θ is the azimuthal coordinate of the ring, p is the azimuthal mode number, \tilde{Ψ} is the Fourier transform of Y from θ to the μ domain, t is the normalized time, αₚ(α_{ref}) is the normalized detuning of the primary (reference) pump, Fₚ (F_{ref}) is the intra-cavity power of the primary (reference) pump, D(μ) is the normalized integrated dispersion of the cavity as a function of relative mode number μ, and μₛ is the mode number of the reference pump in KIS. In general, Eq. (3) admits multi-color soliton solutions. In the KIS regime, the soliton solution does not change from the single pumped one except for a constant drift which is associated with the time-dependence of the reference pump field. Additionally, the reference pump field and the DKS field are stationary with respect to each other in the KIS regime. the frame of reference in Eq. (3) can be changed to obtain an equation with stationary solutions:

$$θ - \frac{( {α}_{ref} - {α}_{p} + 𝒟 ( {μ}_{s} ) )}{{μ}_{s}} t = {θ}^{′} , t = {t}^{′} . \qquad ( 4 )$$

This frame of reference rotates with an angular velocity where the reference pump is stationary. Using

$$\frac{\partial }{\partial θ} = \frac{\partial }{\partial {θ}^{′}} , \qquad ( 5 )$$

$$\frac{\partial }{\partial t} = - \frac{( {α}_{ref} - {α}_{p} + 𝒟 ( {μ}_{s} ) )}{{μ}_{s}} \frac{\partial }{\partial {θ}^{′}} + \frac{\partial }{\partial θ} , \qquad ( 6 )$$

Eq. (3) can be rewritten as:

$$\frac{\partial ψ}{\partial t} = - ( 1 + i {α}_{p} ) ψ + i {\sum }_{μ} 𝒟 ( μ ) Ψ {e}^{i μ θ} + \frac{( {α}_{ref} - {α}_{p} + 𝒟 ( {μ}_{s} ) )}{{μ}_{s}} \frac{\partial ψ}{\partial θ} + i {\vert ψ \vert}^{2} ψ + {F}_{p} + {F}_{ref} exp [ - i {μ}_{s} θ ] . \qquad ( 7 )$$

For convenience, the primes in Eq. (7) are dropped. The MLLE in the form of Eq. (7) admits stationary solutions in the KIS regime as the right-hand side is time-independent. Now, the stability of the soliton in the presence of perturbations can be studied using dynamical techniques. For the given set of parameters, the stationary solution ψ₀ can be calculated using the Levenberg-Marquardt algorithm such that

$$\frac{\partial {ψ}_{0}}{\partial t} = 0 . \qquad Eq . ( 7 )$$

is linearized around ψ₀ to obtain:

$$\frac{\partial Δ ψ}{\partial t} = ℒ ( {ψ}_{θ} ) Δ ψ . \qquad ( 8 )$$

where Δψ is a perturbation and L(ψ₀) is the linearized operator. The eigenvalues of this operator are referred to as the spectrum of the linearized operator or the dynamical spectrum, and they determine the local stability of the system. Solving Eq. (8), the effect of the system on the perturbation after time Δt is obtained:

$$Δ ψ ( {t}_{0} + Δ t ) = exp [ ℒ ( {ψ}_{0} ) Δ t ] Δ ψ ( {t}_{0} ) . \qquad ( 9 )$$

In general, one can decompose any perturbation into a linear combination of eigenfunctions vₙ of L(ψ₀), with corresponding eigenvalues λₙ. Therefore:

$$\begin{matrix}Δψ ( {t}_{0} ) = {\sum }_{n} {a}_{n} {v}_{n} , \\ Δψ ( {t}_{0} + Δ t ) = {\sum }_{n} exp [ {λ}_{n} Δ t ] {a}_{n} {v}_{n} .\end{matrix} \qquad ( 10 )$$

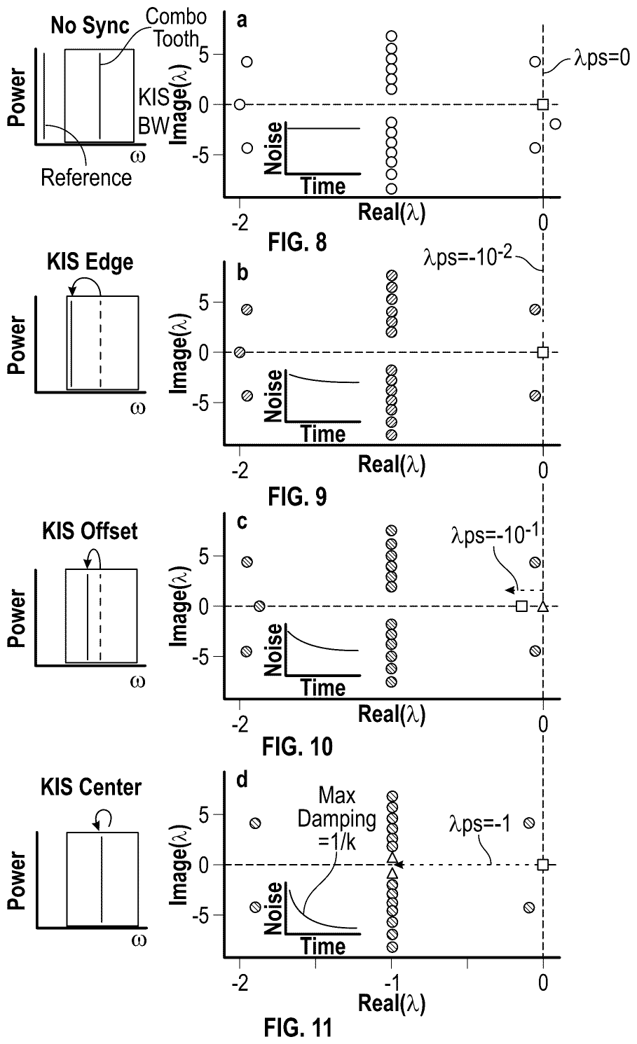

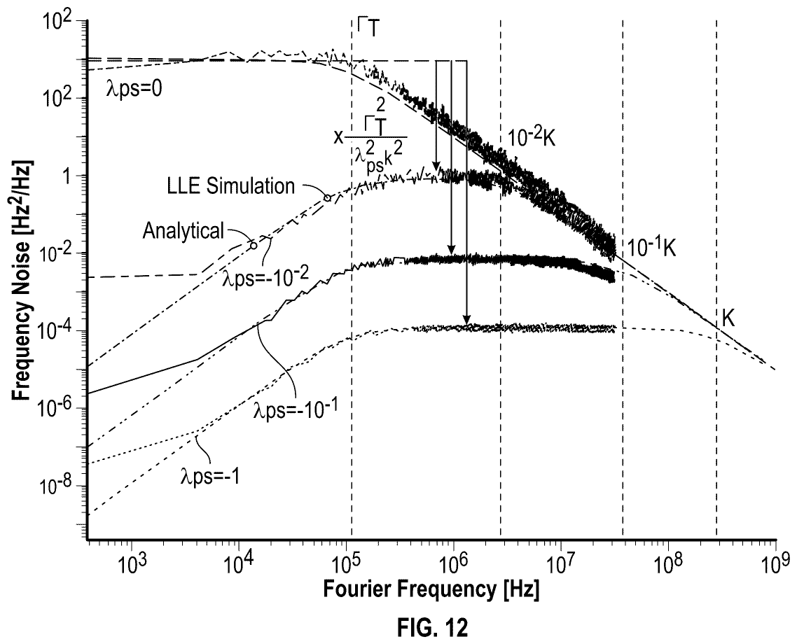

From Eq. (10), it is clear that a perturbation to the DKS grows exponentially if Re(λₙ)>0, persists if Re(λₙ)=0, and damps exponentially if Re(λₙ)<0. In all cases, there is one eigenvalue λₚₛ, referred to as the position-shifting eigenvalue, whose eigenfunction corresponds to perturbations of the DKS position inside the cavity. Perturbations of the form of the position-shifting eigenfunction are responsible for fluctuations in the repetition rate of the soliton. For the singly-pumped DKS (FIG. 8), λₚₛ=0, which implies that perturbations to the soliton position due to noise persist. λₚₛ in the singly-pumped DKS exists at zero because the DKS has a degree of freedom associated with its translational invariance, which is due to the fact that the singly-pumped microresonator system is perfectly symmetric in the resonator's azimuthal coordinate.

However, in the KIS regime, the soliton is trapped by the two pumps, and results in λₚₛ<0 (FIGS. 9-11) which implies that perturbations to the DKS damp exponentially.

In other words, the injection of the reference pump breaks the symmetry in the resonator, meaning that the DKS does not exhibit any translational invariance anymore. When the reference pump's frequency is at the center of the synchronization window, λₚₛ=−1 (FIG. 11) which corresponds to exponential damping of the DKS jitter with the photon lifetime. This is the most negative value that λₚₛ can take as all photons in the cavity take on average a photon lifetime to exit, and therefore sets the fundamental limit for damping of the repetition rate noise, which after accounting for the normalization with respect to the total loss κ=280 MHz, corresponds to exponential damping of the intra-cavity noise by the photon lifetime τₚₕₒₜ=1/κ.

The repetition rate noise manifests as a perturbation to the soliton's intracavity mode frequencies. In the KIS regime, the soliton begins to converge to an equilibrium from this perturbed state. However, the photons that were a part of the perturbation have to exit the cavity in order for the system to be in equilibrium. Owing to the Q of the cavity, these photons leave the cavity on average in a photon lifetime. Therefore, a lower photon lifetime enables the noise to dampen faster. To verify the stability analysis conducted, stochastic LLE simulations are performed to account for intra-cavity TRN, for which the repetition rate can be extracted at every round trip time and processed to obtain its PSD. These simulations account for the impact of TRN on pump detunings α_{p,r}, and the dispersion D, and using either simulated or experimentally determined values for other parameters. In the unsynchronized case (FIG. 8), the simulated repetition rate noise matches well with the analytical one that can be obtained following:

$${S}_{\text{?}}^{\text{?}} ( f ) = 2 \frac{{η}_{T}^{2} {k}_{B} {T}^{2}}{ρ CV} \frac{{Γ}_{T}}{( {f}^{2} + {Γ}_{T}^{2} )} \qquad ( 11 )$$

$$\text{?} \text{indicates text missing or illegible when filed}$$

with η_{T}=∂_{ωrep}/∂T|T₀ calculated when not synchronized, p the material density, C its specific heat, and V the modal volume of the fundamental transverse electric mode, Γ_{T} the thermal dissipation rate, T the temperature, k_{B} the Boltzmann constant, and f the Fourier frequency.

Consistent with the linear stability analysis, the ωᵣₑₚ PSD result from the stochastic LLE exhibits a much lower noise level in the KIS regime (FIG. 11) which is minimized when the reference is at the center of the KIS bandwidth (i.e., where the comb tooth is originally). In the simulation, the frequency noise of the pumps has been neglected, yielding driving fields that are perfect Dirac delta functions spectrally and hence resulting in the reduction of the PSD at low Fourier frequencies. One could derive an analytical expression for the repetition rate noise in the KIS regime, which can be obtained from the linear stability analysis of the MLLE regime:

$$\frac{\partial Δ {ω}_{rep}}{\partial t} = κ {λ}_{\text{?}} Δ {ω}_{rep} + {η}_{T} \frac{\partial Δ T}{\partial t} \qquad ( 12 )$$

$$\text{?} \text{indicates text missing or illegible when filed}$$

with κ=1/τₚₕₒₜ the total loss rate of the cavity and τₚₕₒₜ the photon lifetime, λₚₛ the position-shifting eigenvalue, and Δωᵣₑₚ the repetition rate noise. The PSD of the repetition rate noise can then be derived such that:

$${S}_{rep}^{\text{?}} ( f ) = {S}_{rep}^{lp} ( f ) \times \frac{{f}^{2}}{{f}^{2} + {λ}_{ps}^{2} {κ}^{2}} \qquad ( 13 )$$

$$\text{?} \text{indicates text missing or illegible when filed}$$

Outside of synchronization λₚₛ=0 yields the same expression as the single pump case (Eq. (11)) with a typical Lorentzian profile in the Fourier frequency space. In the KIS regime, the noise spectrum is then damped by the f²/(f²+λₚₛ²κ²) term, linking KIS to the energy exchange rate of the system, as expected from attractors of nonlinear dissipative systems, and is in good agreement with the simulations (FIG. 11) albeit a discrepancy at low Fourier frequency due to the finite simulation finite time and averaging. In comparison to the conventional single pump DKS, the PSD profile of Δωᵣₑₚ is dramatically altered, since at low frequency it follows a S₀f²/Γ_{T}² λₚₛ² κ² profile, with

$${S}_{0} = 2 \frac{\partial ω r e p}{\partial T} \frac{{k}_{B} {T}^{2} {Γ}_{T}}{ρ CV} .$$

As the thermal dissipation rate is much slower than the photon decay rate (Γ_{T}<<κ) in the microring, this hints at the good long term stability of the repetition rate, which will no longer be hindered by incoherent intracavity noise processes such as TRN in contrast to the single pump case that exhibits a typical plateau at S₀/Γ_{T}² at low Fourier frequencies. At high Fourier frequency f>|λₚₛ|κ, the PSD in KIS will follow the Lorentzian profile imposed by the thermal noise, yet the Fourier frequency at which it happens is λₚₛ dependent since a plateau at S₀/λₚₛ²κ² will be observed for fϵ[Γ_{T}; λₚₛ|κ]; however, this plateau occurs at a value that is still much lower than the noise in the single pump case, which follows a 1/f² trend, and reduced from the single-pump low-frequency plateau by a factor Γ_{T}²/λₚₛ²κ².

The statistical fluctuations of the refractive index of the material leading to TRN remain present in the microresonator; however, KIS provides a trapping of the DKS. The dynamics of attractors in non-linear dissipative systems tells us that any perturbations faster than their characteristic energy exchange rate cannot be counteracted. In KIS, the exchange rate being defined by the photon lifetime τₚₕₒₜ=1/κ and the reference laser frequency relative to the KIS bandwidth fixing the zero mode eigenvalues λₚₛ, any noise faster than |λₚₛ|κ will not be influenced by the soliton synchronization and will be experienced as in the single-pumped regime.

The dependence on λₚₛ can be understood such that at the edge of the KIS bandwidth, the synchronization is slower since the soliton must adapt its repetition rate within the nonlinear Kerr effect timescale. This results in a small λₚₛ and hence λᵣₑₚ^{kis} catches up with Sᵣₑₚ^{1p} at relatively low frequencies. In contrast, at the center of the KIS bandwidth, synchronization is faster since the reference pump is already at the frequency for which the soliton exists in the single pump case. This results in a larger |λₚₛ| and a higher frequency at which Sᵣₑₚ^{kis} catches up with Sᵣₑₚ^{1p}.

An advantage of KIS is that the system noise is not limited by material property nor the cavity volume but instead becomes photon-lifetime-limited. Since KIS limits both the loading time for which the reference can be injected in the microring resonator and the photon dissipation of the previously unsynchronized cavity soliton. The above results are similar to the so-called “quantum diffusion limited” counter-propagative solitons. Here, the theoretical timing jitter limitation of solitons are obtained through a Lagrangian approach, where an equivalent to KIS occurs between solitons in each direction, since both systems obey an analogous Alder equation.

This analysis yields a noise limited by the photon lifetime 1/κ. Here such a quantum diffusion limit to a single soliton is expanded, where the synchronization is enabled through entirely controllable external parameters provided by the two laser pumps, instead of using synchronization between two soliton states. While ultra-high Q provides net benefits in terms of reducing the pump power needed to generate Kerr solitons, when it comes to minimizing the impact of intrinsic noise, it is advantageous to reduce Q to have a photon lifetime 1/κ as short as possible. In this context, Si₃N₄ microring resonators present an advantage under KIS compared to much larger volume crystalline resonators with ultra-high-Q (e.g., 10⁹), since the microring exhibits a decrease in the photon lifetime by about three orders of magnitude while retaining a small enough modal volume to enable relatively low pump power DKS existence, and no longer suffers TRN-related limitations thanks to KIS.

KIS quenches the intrinsic noise of the repetition rate (and thus of the individual comb lines), which is now entirely determined by the frequency noise and spectral separation between the two pinned teeth. In the fully free-running lasers case, the two pinned teeth correspond to the main and reference pumps, thereby yielding optical frequency division (OFD) by a factor μₛ².

However, other comb lines can be pinned through feedback to one of the pumps. In particular, the “first” tooth can be pinned through carrier-envelope offset (CEO) frequency (ω_{ceo}) stabilization, providing a larger OFD=M_{ref}², where

$${M}_{r e f} = \frac{ω r e f - ω c e o}{ω r e p}$$

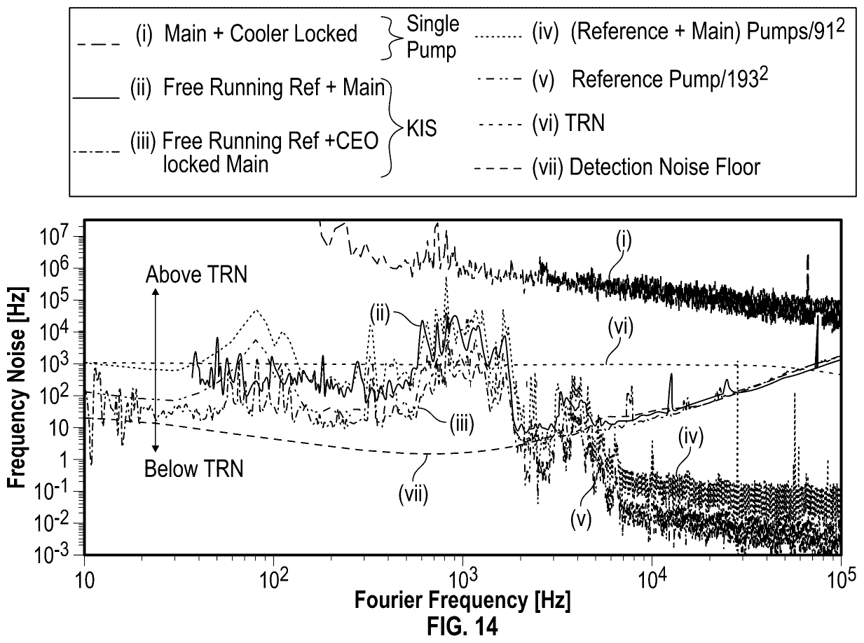

is the comb tooth order where KIS occurs and assuming ω_{ceo} is stabilized by feedback to the main pump (the reverse case could also be considered if ω_{ceo} is stabilized on the reference pump). To demonstrate this effect, the same microring resonator is used as in FIG. 2, pumped at ωₚ/2π=285.467836 THz±3 MHz (≈1050.8 nm) and creating a DW at which the reference pump is transmitted at ω_{ref}/2π=192.559616 THz±2 MHz (≈1557.4 nm), with both frequencies obtained after measuring the repetition rate and CEO. The uncertainty is a one standard deviation value that is dominated by the repetition rate uncertainty. Frequency doubling the reference pump using a second-harmonic generation (SHG) nonlinear crystal 1302 (e.g., a periodically-poled lithium niobate waveguide) (FIG. 13) enables f−2f interferometry against the short DW at 385.369148 THz±4 MHz (about 778.4 nm) for CEO detection (FIG. 13). The CEO can be efficiently detected with more than 60 dB dynamic range as a consequence of the reference pump laser being a comb tooth that provides large power for doubling and the increase in short DW power through the self-balancing effect in KIS. An electro-optic modulation was used to detect ω_{ceo}/2π=−249.91559097 GHz±10 Hz (from electrical spectrum analyzer recording bandwidth) and phase lock ω_{ceo} to a 10 MHz Rubidium frequency standard by actuating the main pump frequency through a proportional-integral-derivative (PID) controller 1304 (FIG. 13). In order to measure the repetition rate ωᵣₑₚ/2π=999.01312 GHz (about ±10 kHz from its linewidth under free-running operation), a similar electro-optic apparatus may be used to modulates two adjacent Kerr comb teeth. This results in their spectral translation through higher-order modulation sidebands, creating a beat note between a sideband from each Kerr comb tooth that resides within a 50 MHz bandwidth and is detected by a low-noise avalanche photodiode (APD). Sᵣₑₚ is measured for three different cases: single pump (FIG. 14 trace i), KIS with free-running pumps (FIG. 14 trace ii), and KIS with a free-running reference and locked CEO (FIG. 14 trace iii). In the first case, the 1/f² trend that is a signature of the TRN-limited behavior expected for a single-pumped cavity soliton, as presented above is observed.

It is worth pointing out that a cooler pump (counterpropagating and cross-polarized relative to the main pump) is used to thermally stabilize the cavity and provide adiabatic access to the DKS. While a low-power cooler (in the 10 mW range) can suppress TRN in microring resonators by about an order of magnitude, such effects were not observed. In particular, the simulated Sᵣₑₚ^{1p}, without a cooler is orders of magnitude lower than the observed noise spectrum (FIG. 14). For soliton access in system 100, the cooler pump must be sufficiently strong, here between 150 mW to 300 mW of on-chip power, to counteract the thermal shift induced by the 150 mW power main pump and access the DKS state. Thermal squeezing of integrated cavities works efficiently only at low cooler power while actually deteriorating the TRN once a critical power threshold is passed. Therefore, the use of a pump cooler to generate a DKS, although convenient, can greatly degrade its noise metrics when not synchronized.

In the KIS regime, Sᵣₑₚ^{kis} does not follow the TRN profile, as expected from theory, as the frequency noise PSD at 2.5 kHz is brought down from Sᵣₑₚ^{1p}≈4×10⁵ Hz²/Hz to Sᵣₑₚ^{kis}≈10 Hz²/Hz in the completely free-running KIS case (FIG. 14 trace ii). When comparing Se and the expected TRN-limited PSD in the single pump case (without the cooler), one can observe that the KIS microcomb has already bypassed the otherwise intrinsic noise limitation of the cavity soliton, beating TRN for frequencies above 2 kHz and only limited by the free-running pump frequency noise. Sᵣₑₚ^{kis} is determined by the OFD factor of the KIS operation. In the above case of two free-running pumps, the measured repetition rate noise is well-reproduced by considering the combined pumps' noise and OFD=μₛ²=91² (FIG. 14 trace (ii)).

When the CEO is locked through actuation of the main pump frequency, Se is further reduced thanks to the larger OFD=M_{ref}²=193² (FIG. 14 trace (v)], and is in good agreement with the measured pump frequency noise divided by this larger OFD factor. In this scenario, the reference remains free-running, while TRN is further beaten by a factor of 15 at low frequency. At high frequency, Sᵣₑₚ^{kis} is limited by the detection floor of the electro-optic apparatus used to measure the approximately 1 THz repetition rate of the KIS DKS (FIG. 14 trace vii).

FIG. 15 illustrates an unsynchronized signal. The lasers from the main pump and reference pump have a different phase velocity and are not phase locked. The carrier-envelope offset (CEO) frequency (ω_{ceo}) is a non-zero value as the reference does not pin a comb.

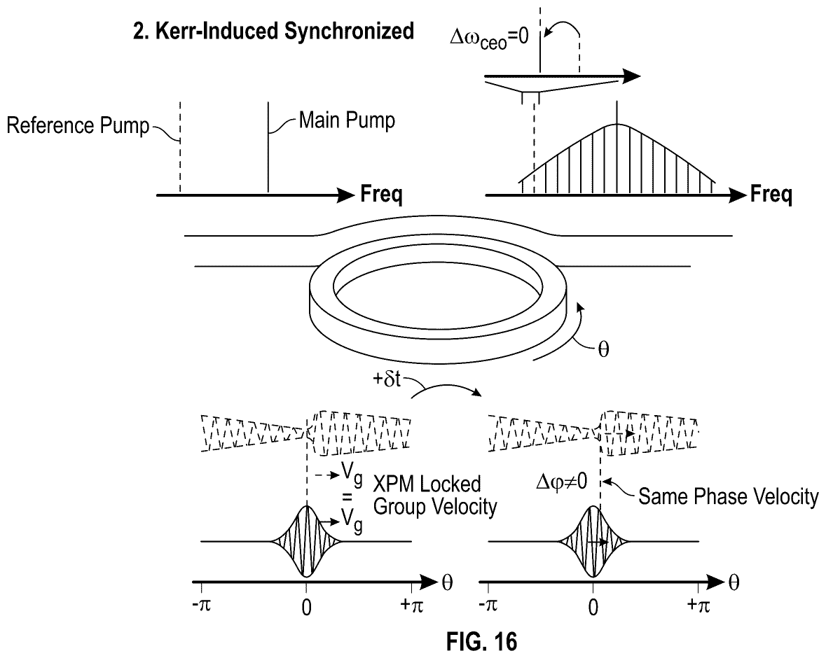

Referring to FIG. 16, a diagram illustrating KIS as used by system 100 is shown. The lasers from the reference pump and the main pump end up having the same phase velocity and are phase-locked and coherent. The reference pins the nearest comb of the OFC, which yields ω_{ceo}=0.

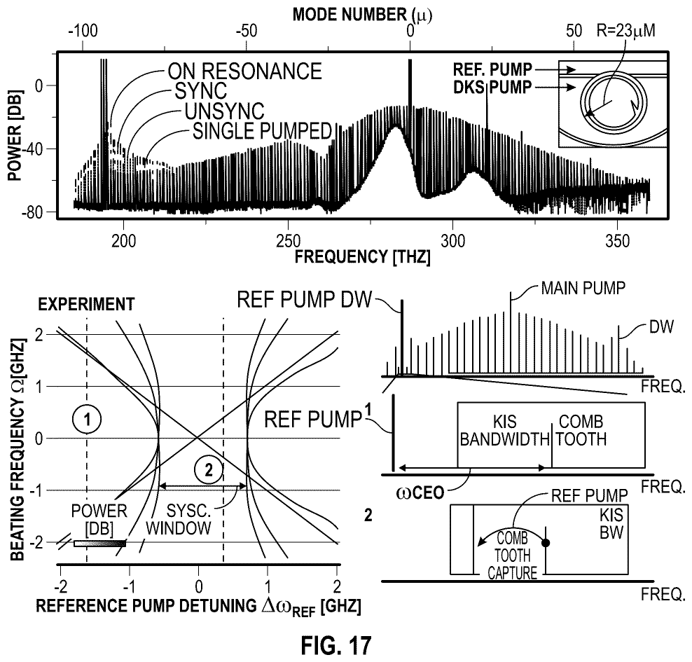

FIG. 17 is a diagram illustrating an experimental demonstration of KIS. In this experiment, the reference pump and the main pump (DKS pump) are coupled through the same waveguide. FIG. 17 illustrates the capture of the comb tooth by the reference pump laser.

Certain embodiments of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different example embodiments provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A system for stabilization of optical frequency combs (OFCs), comprising:
a first laser source configured to provide a first laser having a first frequency;
a reference laser source configured to provide a reference laser, wherein the reference laser is a reference laser having a second frequency different from the first frequency; and
an optical microresonator including:
a microring configured to generate OFCs; and
a first waveguide configured to couple the first laser to the microring,
wherein the optical microresonator is configured to generate a passive Kerr-induced synchronization (KIS) of the OFCs to the reference laser.

2. The system of claim 1, wherein the OFCs include a plurality of comb teeth, and
wherein the reference laser is injected in the optical microresonator and configured to cause the OFC, created by the first laser, to adapt its repetition rate and CEO such that a comb tooth, of the plurality of comb teeth, becomes indistinguishable in frequency and phase with the reference laser.

3. The system of claim 1, wherein dual pinning from the first laser generating the OFC and the reference laser triggering the Kerr-induced synchronization of the system enables bypassing of an intrinsic noises limitation of the system, following a physics of nonlinear dissipative system attractors, and improving a performance of the system up to a performance of the first laser and the reference laser.

4. The system of claim 3, wherein the system is configured to generate an ultra-low noise microwave signal based on the first laser and a reference laser being stabilized to the optical reference.

5. The system of claim 2, wherein a capture by the reference laser of the comb tooth through Kerr-induced synchronization causes an increase in comb tooth power at and around the frequency of the reference laser.

6. The system of claim 2, wherein the reference laser causes a capture of the comb tooth through Kerr-induced synchronization enables self-balancing of the OFCs, increasing a power of the comb teeth on the other side of an OFC spectrum than the reference laser respective to the first laser.

7. The system of claim 2, wherein enabling for higher signal to noise ratio in a detection of carrier envelope offset (CEO) from a nonlinear interferometry between the doubled the reference laser and a closest comb tooth.

8. The system of claim 7, wherein complete locking of the OFC through dual-pinning from the reference laser and locked CEO is provided by servo feedback onto the first laser to lock CEO, with or without the reference laser stabilized to an optical reference.

9. The system of claim 7, wherein complete locking of the OFC through dual-pinning from the first laser and locked CEO is provided by servo feedback onto the reference laser to lock CEO, with or without the first laser stabilized to an optical reference.

10. The system of claim 3, wherein the system is configured for optical clockwork operation, timekeeping, and/or self-reference OFC operation.

11. The system of claim 1, where the reference laser is optically modulated to create sidebands, frequency separated from the reference laser by the modulation frequency, which captures the closest comb tooth, providing Kerr-induced synchronization from one of the sidebands of the reference laser.

12. The system of claim 1, wherein the OFCs include a plurality of teeth,
wherein the system is configured to pin a first tooth of the plurality of teeth through carrier-envelope offset (CEO) frequency (ω_{ceo}) stabilization, and
wherein the first laser source is a dissipative Kerr solution (DKS) pump laser, and wherein the system further includes:
a servo configured to tune the first laser source based on the CEO frequency.

13. The system of claim 12, wherein the system is configured to reduce an intrinsic noise of a repetition rate of the plurality of teeth based on the passive KIS.

14. The system of claim 1, wherein the system is configured to stabilize ω_{ceo} based on feeding back ω_{ceo} to the first laser source or the reference laser.

15. The system of claim 12, further comprising a second harmonic generator configured to double a frequency of the reference laser, wherein the doubled frequency of the reference laser is beat against a closest in frequency comb tooth of the plurality of teeth.

16. The system of claim 1, further comprising a second waveguide configured to couple the reference laser to the microring.

17. The system of claim 1, wherein the reference laser is coupled to the microring by the first waveguide.

18. The system of claim 1, wherein a noise reduction is determined by an energy exchange rate of the system.

19. A method for stabilization of optical frequency combs (OFCs), comprising:
providing by a first laser source a first laser having a first frequency;
providing by an optical reference source a reference laser, wherein the reference laser is a reference laser having a second frequency different from the first frequency; and
generating a passive Kerr-induced synchronization (KIS) of the OFCs to the reference laser by an optical microresonator, wherein the optical microresonator includes:
a microring configured to generate OFCs, wherein the OFCs include a plurality of teeth; and
a first waveguide configured to couple the first laser to the microring; and
reducing an intrinsic noise of a repetition rate of the plurality of teeth based on the passive KIS.

20. A system for stabilization of optical frequency combs (OFCs), comprising:
an optical microresonator including:
a microring configured to generate OFCs; and
a first waveguide configured to couple a first frequency laser and a second frequency laser to the microring,
wherein the optical microresonator is configured to generate a passive Kerr-induced synchronization (KIS) of the OFCs to the second frequency laser, the second frequency laser being lower in frequency than the first frequency laser, and
wherein the system is configured for enabling a noise reduction, which is determined by an energy exchange rate of the system.
